(19) United States
(12) Patent Application Publication
(10) Pub. No.: US 2006/0100850 A1
(43) Pub. Date: May 11, 2006

(54) Methods and systems for conveying instructions for medications

(75) Inventor: Chung-Suk Charles Lee, Durham, NC (US)

Correspondence Address: THE ECLIPSE GROUP, 10605 BALBOA BLVD., SUITE 300, GRANADA HILLS, CA, 91344, US

(73) Assignee: Polyglot Systems, Inc., Morrisville, NC (US)

(21) Appl. No.: 11/303,519

(22) Filed: Dec. 16, 2005

Related U.S. Application Data
(63) Continuation-in-part of application No. 10/421,084, filed on Apr. 23, 2003.
(60) Provisional application No. 60/637,295, filed on Dec. 17, 2004.
(60) Provisional application No. 60/375,037, filed on Apr. 24, 2002.
(60) Provisional application No. 60/420,372, filed on Oct. 22, 2002.

(51) Int. Cl. G06F 17/20

(52) U.S. Cl. 704/8

(57) ABSTRACT

An instruction generation system and related methods to allow a user using inputs to prompts in a first language to generate written and audio instructions in a second language to an instruction recipient. An instruction generation system can be used by a health care provider to provide instructions related to new medications to be administered to a patient or to the stopping or avoiding of certain medications by a patient. The instruction generation system can be deployed without the capacity for on-the-fly translation as the system maps the instruction concepts and context for the instructions onto previously stored written and audio instructions for presentation to the instruction recipient. This abstract is a tool for those searching for relevant disclosures and not a limit on the scope of the claims.

This application claims priority to and incorporates by reference U.S. Provisional Application No. 60/637,295 filed Dec. 17, 2004 for Methods and Systems for Conveying Instructions for Medications. This application claims priority to and incorporates by reference U.S. patent application Ser. No. 10/421,084 filed Apr. 23, 2003 for Inter-Language Translation Device and the priority documents for that application, more specifically, U.S. Provisional Patent Application Ser. No. 60/375,037 filed on Apr. 24, 2002 for Communication Solution for Exchanging Information Across Language Barriers and U.S. Provisional Patent Application No. 60/420,372 filed Oct. 22, 2002 for Inter-Language Dual Screen System.

### BACKGROUND OF THE INVENTION

1. Field of the Invention

This invention relates generally to computer apparatus and methods. More specifically, this invention is in the field of computer apparatus and methods designed to facilitate communication between a user speaking a first language and a message recipient that does not understand the first language but can understand a second language. One particular application of the present invention is in conveying information from a user such as a health care provider to a recipient about medication to be administered to a patient which may be either the recipient or a patient affiliated with the recipient.

2. Background

Limited English Proficient

Nearly 47 million people speak a language other than English at home (Reference 1). Of this population, about 20 million belong to a group called the Limited English Proficient (LEP)—those who speak English less than “very well”. This LEP population represents 1 of every 15 people in the United States. In urban areas, the prevalence of this population is even higher. The Brookings Institution estimated that during 2004, 1 of every 8 people in the Washington, DC area were LEP (Reference 2).

Multilingualism is spreading rapidly across the United States, in rural states and counties as well as urban environments (Reference 3). Between 1990 and 2000, fifteen states experienced more than 100% growth in their LEP population—Arkansas, Colorado, Georgia, Idaho, Kansas, Kentucky, Minnesota, Nebraska, Nevada, North Carolina, Oregon, South Carolina, Tennessee, Utah, and Washington (Reference 4). There are indications that the US healthcare system is struggling to keep pace.

Medication Errors & LEP

According to the 1999 report “To Err Is Human: Building a Safer Health System”, the Institute of Medicine (IOM) emphasized patient safety as a growing concern in the United States (Reference 5). The IOM estimates that 44,000 to 98,000 Americans die each year as a result of medical errors. Medication errors alone account for about 7,000 of these annual deaths and cost approximately $2 billion for the nation as a whole. Another study in 2003 found that approximately 770,000 are injured or die each year in hospitals due to adverse drug events (Reference 6).

In 1998, nearly 2.5 billion prescriptions were dispensed by the U.S. pharmacies at a cost of about $92 billion. (Reference 7) Numerous studies have documented errors in prescribing medications, (References 8-11) dispensing by pharmacists, (Reference 12) and unintentional non-adherence on the part of the patient (Reference 13). Many other researchers have shown how the lack of language services creates a barrier to, and diminishes the quality of, healthcare for the LEP population (References 14-15).

An important element of healthcare is the provision of medication to be administered to a patient after the patient is back home and no longer under the direct care of health care providers. The instructions for the use of medication include a number of attributes including but not limited to the specific medication to be administered, the way the medication is to be administered (route of administration), the dose to be administered, the frequency that the dose should be administered, possibly additional instructions on how the dose should be administered, possibly various warnings relevant to the medication, and warnings about possible side effects of the medication (if any). The recipient of the instructions may or may not be the patient that will receive the medication. Frequently the recipient may be a parent of a child patient, the child of an elderly patient, or a person responsible for the care of an animal receiving medical treatment.

As discussed in pending application Ser. No. 10/421,084 the prior art solutions of translators is not particularly feasible as the recipient of the information may speak an unusual language making it difficult to find a translator capable of providing medical instructions. Even if a translator can be found, the added expense and delay of obtaining a translation is undesirable. In the context of instructions for medications, it is advantageous to provide both vocalized instructions for the recipient to hear while present with the service provider and written instructions that can be referenced later. Some translation services that provide translations for uncommon languages are telephone based services which do not lend themselves towards the provision of written instructions for the recipient to take home. (“uncommon” in the context that the language is spoken by only a small percentage of people in that location while it may be a very common language when viewed in the context of the entire world).

Phrase translation books are used to help bridge language gaps but are not adequate solutions for conveying detailed instructions regarding medications as these methods lack precision in a type of communication where precision matters. It is desirable for the precise communication for the administration of a specific medication with specific instructions to be translated in a repeatable way and to be subject to documentation as what specifically was communicated. As noted above, communications regarding medications are typically vocalized and provided in a written handout. Phrase books do not lend themselves to this dual-mode of communication.

These the various references cited in the preceding discussion:

(1) US Bureau of Census. Profile of Selected Social Characteristics. 2000.

(2) The Brookings Institution. Polyglot Washington: Language Needs and Abilities in the Nation's Capital. 2004.

(3) Peter Kilborn, Lynette Clemetson. Gains of 90's Did Not Lift All, Census Shows. New York Times 2002 Jun. 5.

(4) US Bureau of Census. 1990 and 2000 Decennial Census. 2000.

(5) Institute of Medicine. To Err Is Human: Building a Safer Health System. Washington, DC: National Academy Press; 2000.

(6) Kaushal R, Shojania K G, Bates D W. Effects of computerized physician order entry and clinical decision support systems on medication safety: a systematic review. Arch Intern Med 2003 Jul. 23;163(12):1409-16.

(7) National Wholesale Druggists' Association. Industry Profile and Healthcare Factbook. Reston, Va.; 1998.

(8) Johnson K B, Butta J K, Donohue P K, Glenn D J, Holtzman N A. Discharging patients with prescriptions instead of medications: sequelae in a teaching hospital. Pediatrics 1996 April;97(4):481-5.

(9) Hallas J, Haghfelt T, Gram L F, Grodum E, Damsbo N. Drug related admissions to a cardiology department; frequency and avoidability. J. Intern Med 1990 October;228(4):379-84.

(10) Hallas J, Gram L F, Grodum E et al. Drug related admissions to medical wards: a population based survey. Br J Clin Pharmacol 1992 January;33(1):61-8.

(11) Willcox S M, Himmelstein D U, Woolhandler S. Inappropriate drug prescribing for the community-dwelling elderly. JAMA 1994 Jul. 27;272(4):292-6.

(12) Knox R. Prescription Errors Tied to Lack of Advice: Pharmacists Skirting Law, Massachusetts Study Finds. Boston Globe 1999 Feb. 10;B1.

(13) Einarson T R. Drug-related hospital admissions. Ann Pharmacother 1993 July;27(7-8):832-40.

(14) Flores G, Laws M B, Mayo S J et al. Errors in medical interpretation and their potential clinical consequences in pediatric encounters. Pediatrics 2003 January;111(1):6-14.

(15) Gandhi T K, Burstin H R, Cook E F et al. Drug complications in outpatients. J Gen Intern Med 2000 March;15(3):149-54.

### SUMMARY

An instruction generation system and related methods to allow a user responding to prompts in a first language to generate written and audio instructions in a second language for provision to an instruction recipient. An instruction generation system can be used by a health care provider to provide instructions related to new medications to be administered to a patient or to the stopping or avoiding of certain medications by a patient. An instruction generation system could be used to generate instructions for a recipient in situations other than medication instructions. The instruction generation system can be deployed without the capacity for on-the-fly translation as the system maps the instruction concepts and context for the instructions onto previously stored written and audio instructions for presentation to the instruction recipient.

The invention can be implemented as a method of constructing an instruction by a user using a first language for delivery to a recipient in a second language, different from the first language. The method includes providing a medication identifier to an instruction generation system (such as the name of the medication or a code representing a medication). The method includes providing a medication administration route to the instruction generation system. The method includes providing a medication regime to the instruction generation system. The method includes the option of electing to provide at least one medication qualifier. The method includes the option of electing to provide at least one medication caution. The method includes the option of electing to provide at least one medication side effect. The method includes playing a set of audio instructions in the second language to convey information comprising: a name of the medication, a set of directions for the administration of the medication, any medication cautions provided by the user, and any possible medication side effects provided by the user.

The invention can be implemented as a method of presenting a set of instructions for a set of at least one medication, the instructions created in an instruction generation system based on inputs in a first language, the instructions for delivery to a recipient in a second language, different from the first language. For each medication to be provided to the recipient, the method calls for receiving a set of inputs from the user comprising information to identify the medication, a set of directions for the administration of the mediation, any medication cautions provided by the user, and any possible medication side effects provided by the user. For each medication to be provided to the recipient, the method calls for allowing the user to review the set of received inputs and to accept or reject the set of received inputs. The method calls for presenting in the second language the number of medicines to be provided to the recipient; and for each medication to be provided to the recipient presenting in the second language instructions based upon the set of inputs from the user comprising information to identify the medication, a set of directions for the administration of the mediation, any medication cautions provided by the user, and any possible medication side effects provided by the user.

An aspect of the invention can be implemented in a method of constructing an instruction by a user using a first language for delivery to a recipient in a second language different from the first language, the method calling for providing to an instruction generation system using the first language a set of at least one medicine that should not be administered to the patient; and presenting the set of at least one medicine that should not be administered to the patient to the recipient in the second language.

While these examples are useful for providing an overview of this disclosure, they are not meant to be limiting as aspects of this invention can be implemented in various settings and combinations.

### BRIEF DESCRIPTION OF THE FIGURES

FIG. 1 is a representation of a computer system as known in the prior art.

FIG. 2 is an illustration of a set of system components for providing context for the use of the present invention.

FIG. 3 is a flow chart of one sequence of steps for creating and delivering a set of instructions.

FIG. 4 is a flow chart of one particular set of sub-steps for obtaining information from the health care provider (user) to be communicated to the instruction recipient about a specific medication.

FIG. 5 shows a touch screen presented to a user to collect the information for a medicine.

FIG. 6 illustrates the one example of the process to provide the medication identifier.

FIG. 7 shows a user interface to obtain the route of administration for the medication.

FIG. 8 shows a second screen that is presented when the user specified “mouth” as the route of administration.

FIG. 9 illustrates a set of dosage options that are relevant for the route of administration being mouth and pill/tablet/capsule.

FIG. 10 illustrates an input screen with a list of frequency choices.

FIG. 11 illustrates the provision of a list of relevant qualifiers for mouth and pill/tablet/capsule.

FIG. 12 provides a second screen of qualifiers for the route of administration of mouth and pill/tablet/capsule.

FIG. 13 illustrates the presentation of a set of durations.

FIG. 14 shows one screen providing a set of choices for a maximum dosage caution.

FIG. 15 illustrates a screen presenting a set of side effects and a skip button.

FIG. 16 illustrates a screen that provides the user with a chance to review the inputs provided in connection with medicine 1.

FIG. 17 is a screen used in the process of providing written and audio instructions to the instruction recipient based on the previously provided input from the user.

FIG. 18 provides a set of text to the user in the user's language of what is about to be conveyed to the recipient of the instructions.

FIG. 19 is an example of an input screen for a list of medicines for the patient to stop taking.

FIG. 20 is a screen used to print and provide audio instructions regarding stopping or avoiding certain medicines.

FIG. 21 is a high level representation of the process for creating instructions in a second language.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In order to provide context for the present invention and to highlight the features of the invention with meaningful examples, the invention is described in the context of an emergency room for a hospital. In this scenario, the various service providers within the hospital are assumed to know English. Some, but possibly not all the service providers know some form of Spanish—most likely the form of Spanish spoken in Mexico. In this example, the population of people that come to the emergency room for services includes people that do not speak English. As at least some of the arrivals at an emergency room do not have an appointment or a pre-existing relationship with the service providers, it is possible that someone will walk into the emergency room needing assistance and no one will be able to communicate to that person.

Sometimes the person (recipient of instructions) is the person who will use the medication (the “patient”). Other times the person who needs to receive medication instructions from the service providers is a care giver for the patient needing the medication. Typical examples include a parent receiving information about medications for a child, or a young relative receiving information about medications to be provided to an elderly person needing care. It is also possible that the recipient of information is a responsible for administering medication to an animal patient.

One commercial embodiment of the present invention is found in the ProLingua^{SM} Med Wizard™. The ProLingua^{SM} Med Wizard™ is a software-based application that enables rapid creation of patient medicine instructions. In the preferred embodiment, the Med Wizard™ application contains two main functional components: 1) a medicine instruction assembler, and 2) a processor that writes and speaks the generated instructions in a foreign language. This document describes the Med Wizard™ software program that can integrate with other programs to create a system for communicating with people who experience difficulty speaking English.

Hardware

The present invention includes computer software running on a computer. The software must be stored on media and be accessible by a processor which executes the program. The program must be able to receive input from the user and possibly some information directly or indirectly from the recipient such as the language that the recipient understands. The program must be able to act through the computer system to communicate to the user and to the recipient.

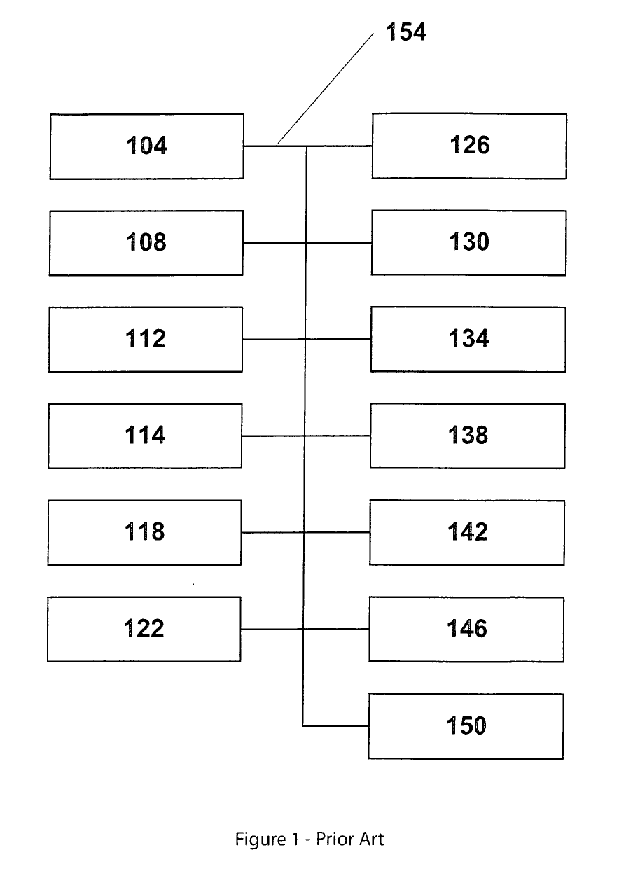

Computer systems such as personal computers are known in the art can be represented generically by FIG. 1. Such a system will comprise a number of separate pieces but can be diagrammed as follows:

Element 104 is an I/O Controller. An Input Output Controller works with the CPU for handling certain aspects of interactions with input/output devices.

Element 108 is a DMA controller to allow direct communication between certain peripherals and RAM.

Element 112 is the Central Processor Unit (CPU or Microprocessor). The CPU executes instructions and manipulates data.

Element 114 is the Clock. The clock provides the one or more clock signals used by other components.

Element 118 is the RAM (Random Access Memory) which is used for temporary memory when executing software.

Element 122 is the ROM (Read Only Memory) which contains permanent memory such as start up instructions for the CPU.

Element 126 is a Mass Storage Device. Most computers have one or more mass storage devices such as hard drives that store programs and data.

Element 130 is a Media Drive. Most computers have one or more media drives such as CD drives or disc drives which can read programs and data from removable media. Many of these drives can also write to removable media.

Element 134 is a Display. Most computers have one or more displays that provide a means for displaying text or graphics.

Element 138 is an Input Device. Most computers have one or more input devices such as keyboards, computer mouse, touch pad, touch screen, light pen, digitizer tablet, or joy stick. Most computers have more than one input device such as a keyboard and a mouse.

Element 142 is a Network Connection. Many computers have one or more network connections. The network connection may include a specialized card such as a NIC card (network interface card), or a wireless card to enable a particular type of wireless connection such as Bluetooth or one of the versions of 802.11.

Element 146 is a Printer. Most computers have some access to a printer or other output device that produces output on paper. These include printers, plotters, bar code printers. Some computers access printers through the network connection.

Element 150 is a Speaker. Most computers have one or more speakers to provide audio feedback, music, sound effects, and voice.

Element 154 represents the buses. The various components in the computer are connected by a set of buses that carry data, control signals, and addresses. As the subject matter of this patent does not involve an improvement to computer buses, the buses are shown in an over simplified manner to avoid unnecessary clutter.

Those of ordinary skill in the art will recognize that FIG. 1 does not capture all of the subcomponents necessary to operate a computer (no power supply for example). FIG. 1 does not show all possible variations of computers as certain elements can be combined together such as combining the clock and the CPU. Further, a computer may have more elements than are shown in FIG. 1 including multiple instances of components shown in FIG. 1 and additional elements not shown in FIG. 1. Finally a computer can be configured to be lacking one or more elements shown in FIG. 1. For example a computer can be configured to operate without a DMA controller, or some elements of the computer of FIG. 1 can be removed from the computer, especially if it has access to such components through a network connection.

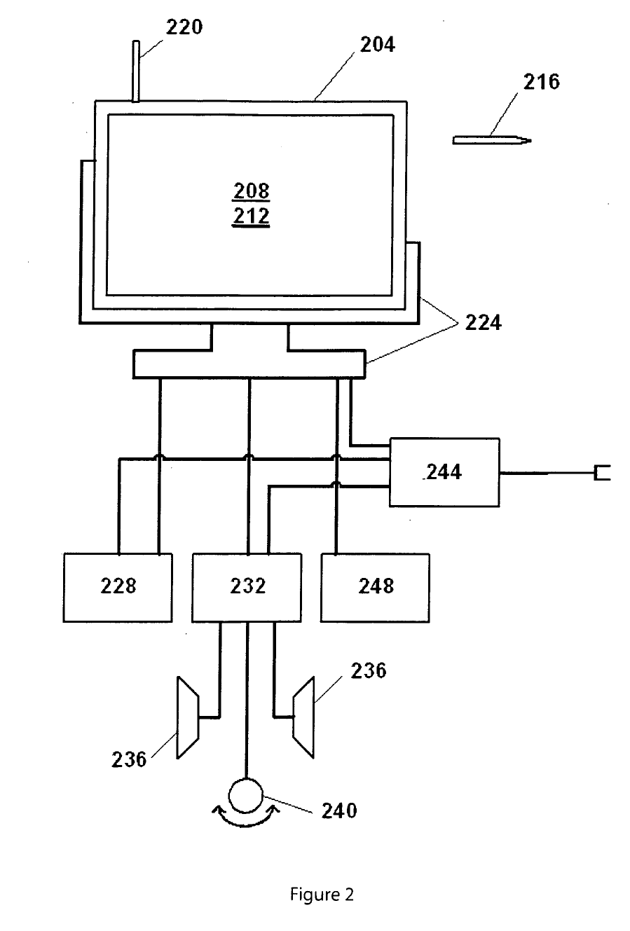

FIG. 2 shows the system of components that is useful for providing context for the use of the present invention. While it is useful to provide a concrete example in order to provide context, such an example should not be viewed as a set of requisite limitations as other hardware combinations are possible. The invention could be implemented on a Personal Digital Assistant (PDA) or other device capable of running software, receiving the necessary inputs, and communication with external devices such as speakers and printers either directly or indirectly though a wired or wireless communication link.

Returning now to the example in FIG. 2, a tablet computer 204 contains the various components shown in FIG. 1 except that the tablet computer has only a printer port rather than a printer and the speakers are external to the tablet computer 204.

The elements of interest include the display 208 and the tablet input 212 which is activated by the contact or proximity of a stylus 216. Although the surface of the display is the same as the surface of the tablet input, these are functionally two different components. As an implementation detail, it is useful to note that there are advantages in many situations in having more than one stylus, for example to reduce the opportunity for medical cross-contamination between a health care provider and a person providing input to the system.

The tablet computer 204 may have its own wireless connection 220 (the rectangular box protruding from the tablet computer is merely included to provide something to label and does not represent the appearance of the wireless connection).

For this example, the tablet computer 204 is placed in a docking station 224. The docking station 224 allows the tablet computer to be placed in an orientation so it can be seen while resting on a rolling cart. The docking station with the tablet computer can be mounted on a surface that can be easily rotated if desired between an optimal position for viewing by the user and an optimal position for viewing by the recipient of information. A turntable such as a “Lazy-Susan” device of adequate capacity is suitable for this purpose. Ideally, the tablet computer 204 is locked into the docking station 224 and the docking station 224 is locked to the turntable which is in turn locked into the rolling cart.

As is known in the art, the tablet computer 204 and docking station 224 can be configured to mate to provide electrical connection to the various ports within the docked tablet computer 204. This can be done by mating with the normal ports or through a special docking bus port (not shown). The net effect is that the docking station 224 has ports that are electrically connected to the docked tablet computer 204.

Thus a printer 228 can be connected to the docking port 224 and placed on the mobile cart with the tablet computer system.

FIG. 2 shows an external speaker controller 232 is mounted over the docking station 224 and is connected to one or more audio inputs on the docking station 224. The speaker controller 232 is connected to one or more speakers 236. A volume control 240 is connected to the speaker controller 232 and placed where it is easy to access by the user and recipient of the instructions.

As the system is located on a mobile cart, a rechargeable battery 244 located on the mobile cart provides power to the various components.

Element 248 highlights that the docking port 224 has a network connection that can be used to connect the tablet computer 204 to an external network (not shown) via an appropriate connector such as an Ethernet cable (not shown). The use of a network connection is one way to load the necessary software and any updates. As most tablet computers do not have an internal media drive, the other way to load programs onto the tablet computer would be through an external media drive, including CD drives, DVD drives, memory stick, or other media drives. One could also use a keyboard such as an external keyboard connected to a USB port to type in programs.

Examples of hardware choices for the components in FIG. 2 are set forth below to provide further context for one device to use the present invention.

Tablet Computer—Microsoft Windows Tablet PC Model M1200 distributed by Motion Computing (www.motioncomputing.com; Austin, Tex.). The tablet computer can be locked to the docking station using a Kingston-type notebook lock (PC Guardian; San Rafael, Calif.). Preferred Accessories include a USB Keyboard and a DVD/CDR Drive.

Speaker Controller—PowerMate multimedia controller for volume control (Griffin Technology, www.griffmtechnology.com, Nashville, Tenn.)

Docking Station—Model: M-series Flexdock distributed by Motion Computing. Note, the docking station is secured down to the turntable using security screws.

Turntable—Custom made 16″ diameter hard surface mounted to a lazy-Susan turnstile mechanism. Note, the turntable is secured to the cart using screws.

Cart—Werndl Communicator distributed by Werndl (a subsidiary of SteelCase, Inc. www.steelcase.com, Grand Rapids, Mich.)

Software

The tablet computer 204 is altered by the operation of software stored in memory within the tablet computer 204. The software includes the instructions and data necessary to direct the computer to display images as discussed below, receive input from the tablet as discussed below, and interact with the speaker controller, printer, and any external networks as discussed below. The software may be comprised of a series of files. In most instances, a programmer will use tools within one or more pieces of application software such that the actual program that alters the computer is a combination of application software written by a third party and additional program files written by the programmer to operate the computer and access the required data.

A preferred embodiment of the present invention has been written while primarily using a combination of the following tools: Flash MX—(Macromedia, www.macromedia.com)—for the core application development; Flash Studio Pro—(multi.dimensional.media, www.multimedia.com) for functional enhancements for Flash; Photoshop CS—(Adobe, www.adobe.com) for graphics design; Illustrator CS—(Adobe, www.adobe.com) for vector graphics development; Visual Studio—(Microsoft, www.microsoft.com)—to add custom Windows functionality; Word—(Microsoft, www.microsoft.com)—template creation and assembly in multiple languages; Sound Forge XP Studio—(Sound Forge, www.sonicfoundry.com) for sound recording and processing; Setup Factory—(IndigoRose, www.indigorose.com) for an installer utility.

Those of skill in the art understand that a common use of a tablet computer is to display certain indicators such as buttons or items for selection and to provide input zones behind these displayed objects so that the movement of the stylus (or finger on a touch screen) to make contact or come in close proximity provides an input that has been programmed to correspond to the particular displayed indicator. In order to avoid repeating this concept throughout this application, the displayed item will be treated as an input selection choice without making the displayed image/zone of input distinction.

Overview of the Process of Providing Instructions Regarding Medication

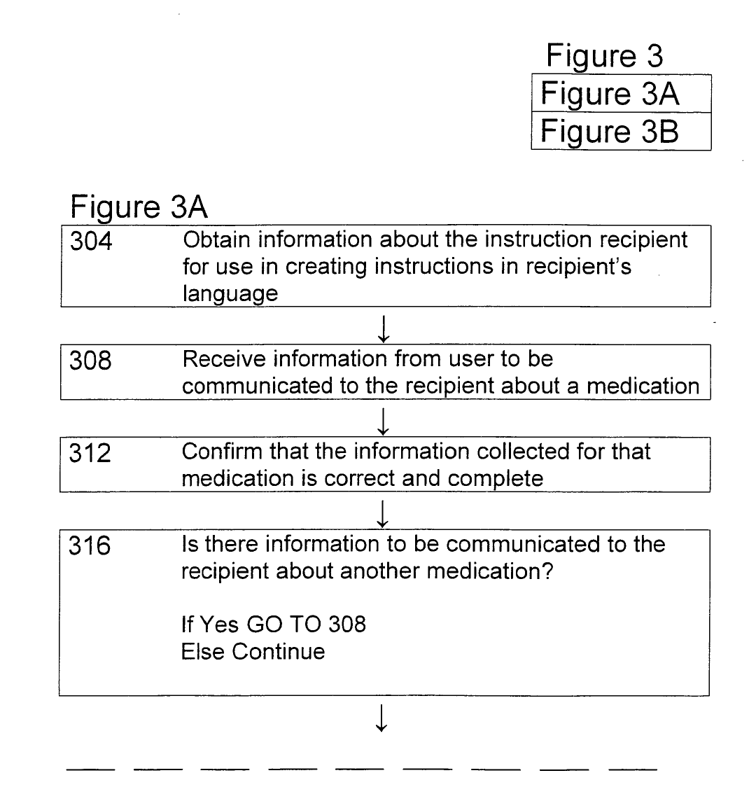

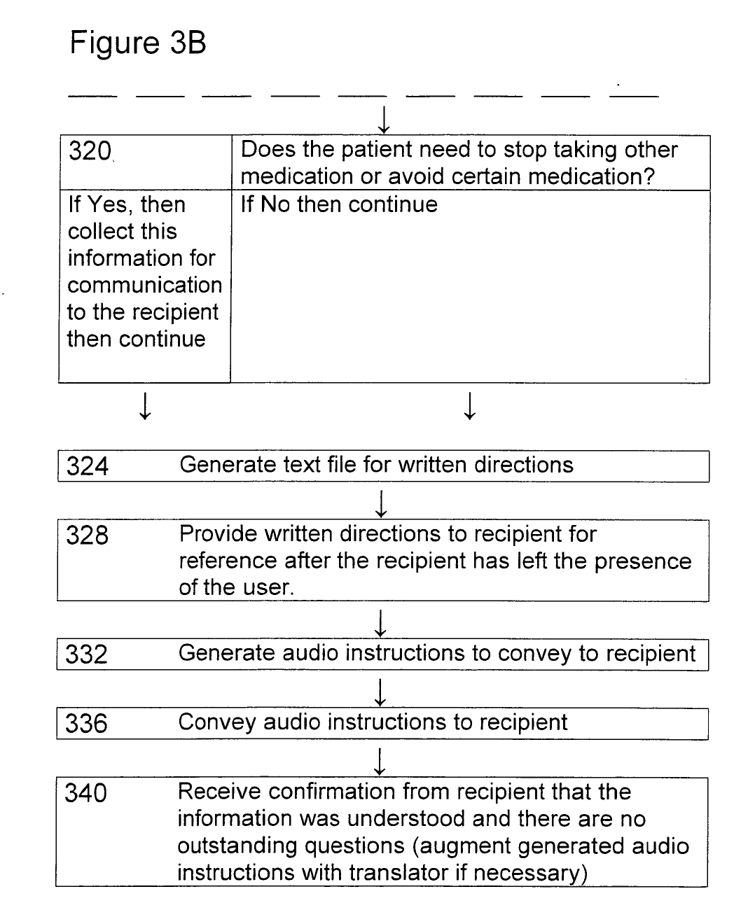

The process of providing instructions regarding medication to a person who does not speak the same language as the health care provider can be described as shown in FIG. 3.

Step 304 is to obtain information about the recipient of the information and the context of the situation for use in creating instructions in a language known to the recipient but different than the language of the health care provider (user) of the instruction generation system. Co-pending and commonly assigned U.S. patent application Ser. No. 10/421,084 describes various ways to obtain a language spoken by the recipient. This material has been incorporated by reference and will not be repeated in detail here. Suffice it to say that the recipient can be provided a number of stimuli such as displays of maps, or flags, or written statements on the screen to allow the recipient to indicate provide information to the user. While identification of a flag or location on a map will not always provide a single possible language, it is likely to narrow down the choices so that written or audio material in languages used in that country or area can be proffered as choices for the recipient to select. Depending on the nature of the system used for this portion of the interview, the recipient may actually provide direct input to the system by actuating a touch screen or some other computer input device. In other instances the input may be indirect as the recipient is asked to nod the head or raise a hand when the appropriate language choice is presented.

In addition to the language for use in communicating to the recipient, it is useful for many languages to have the gender of the recipient and if the recipient is not the patient that will be receiving the medication, the gender of the patient. Thus for this example of contexts, there are six combinations of gender of recipient and status of patient (male/self, male/other male, male/other female, female/self, female/other male, female/other female). Other systems might have less context choices such as a system that does not track the gender of the recipient but only of a third party patient (thus the context cases are you, male third party, and female third party).

Not every instruction will use all the context information available to the system. But it is useful to have the context information for the instructions that do use it. For example, a number of instructions may focus on the third party recipient of the medication rather than the person receiving the instructions. But the next sequence of instructions may focus on how the instruction recipient needs to prepare the medication or administer it such that the gender of the instruction recipient becomes relevant.

Sometimes the gender of the person receiving the medication can be used to eliminate irrelevant choices from being presented. For example, if the person receiving the medication is a male, then vaginal would not be a relevant route of administration.

If necessary in order to communicate in other languages additional information could be obtained. For example, the designers of a system may decide that use of marital status would make the audio instructions more personalized. Or the designers of the system might decide that for a particular language it is important to distinguish between a young patient and an elderly patient if there was not a generic term that would work for both of these types of patient. Adding additional variations and combinations adds to the number of phrases that must be recorded and stored so there is an incentive to limit the number of combinations.

If the instruction generation system is used in a clinic or some other setting with access to patient records, the language(s) of competency for that patient or the patient's caregiver could be maintained in the record so that there is not a need to ascertain a language of competency but only a need to make this language designation available to the instruction generation system.

Step 308 is receive information from the user to be communicated to the recipient regarding a medication. As described in greater detail below, for each medication to be used for the patient, certain information needs to be conveyed such as the administration route, administration regime and other information such as cautions and possible side effects. The user needs to convey this information into the instruction generation system. The user conveys this information in a language understood by the user.

Step 312 seeks confirmation from the user that the information collected for a particular medication is correct and complete. While a system would not have to have this step to operate, reviewing the inputted information and confirming that it is accurate and complete is a good idea. Those of skill in the art will recognize that there are various user interface options to allow for revisions to a set of collected data in including simply deleting that set of data for a particular medication or allowing the user to go back as many input screens as needed in order to correct or augment the information provided.

Step 316 repeats the process of obtaining information for each medication to be provided for the patient and confirming the accuracy and completeness of the data.

Step 320 collects any related instructions to stop taking other medication or avoid using medications. For example, if the user is prescribing a stronger medication for a particular ailment it may be necessary to stop taking a weaker medication or it may be prudent to avoid taking aspirin while taking certain medications. Additional details are provided below about collecting the stop or avoid instructions. While one could potentially collect this information at other stages in the process, it is thought that users will find it most natural to list the stop and avoid items after completing the instructions for the complete set of new medicines. Note that a system that knows the actual medication being added (rather than passing text for the medication name) could provide suggested stop/avoid instructions for the user to accept.

Step 324 is generate a text file for written directions. While the text file could have a one to one correspondence with the words used in the audio instructions (described below), often they will not. Instructions regarding medication often use gender neutral forms such as “you” and ignore context such as the fact that the patient is not the recipient of the information. Minimizing the number of combinations of gender and context reduces the need to create, store, and update variations of each of the instructions. Note that since the text file is generated without active involvement of the user, the text file could be created as instruction set is created and then printed later at the request of the user.

Step 328 is provide the recipient written directions so the recipient can refer to the directions later. Optionally, a set of written direction in both the language of the user (presumably the language used for business records) and the language of the recipient can be printed and stored with the patient's medical records (or electronically routed to the electronic file for that patient). The written instructions could be created after the recipient has received the audio instructions and confirmed that the instructions are understood and sufficient as this would eliminate the printing of instructions that need to be revised, but there is an advantage to printing the written instructions before providing the audio instructions. The advantage is that the written instructions may help the recipient understand the audio instructions or may provide a place for the recipient to highlight important instructions as the audio version is presented. As illustrated with the various user interface screens described below, the step of providing the written list of medicines to stop/avoid could be initiated by a separate input to the system from the input that causes the of printing the instructions for new medicines as there may be instances where there is a need to stop/avoid certain medicines without a need to add new medicines. One of skill in the art will recognize that a single request to print all instructions could be implemented with software to create the output set of instructions for cases where there is new medicine without stop/avoid instructions, both new medicine and stop/avoid instructions, or cases of just stop/avoid instructions. As noted below, the list of medicines to stop are printed on one page and a list of medicines to avoid are printed on another page so that each page can be presented in connection with an audio instruction that this is the list of medicines to stop (or avoid).

Step 332 generate audio instructions to convey to recipient. While the audio instructions could be generated and delivered to the instruction recipient after each set of entries by the user, it is most convenient to convey all of the instructions after all of the information has been provided to the instruction generation system. As described in greater detail below, audio segments corresponding to the various instructions provided by the user are selected for the appropriate language known by the recipient. In instances where the instruction makes use of other contextual information such as the gender of the recipient or the status of the patient, multiple audio files exist for that instruction, one audio file for each of the contextual variations.

Step 336 convey the audio instructions to the recipient. This could be augmented with visual material such as text or graphics provided to a display screen that can be viewed by the recipient.

Step 340 as described in more detail below, it is important to receive a confirmation that the recipient understands the directions and does not have an unanswered question. While it is hoped that the instruction generation system will be sufficient to fully convey the information to the recipient without further conversation, this will not be so 100% of the time. Even when the recipient and the health care provider speak the same language, sometime the delivery of instructions regarding medication will not make sense to the recipient or will provoke additional needs for information. Thus, it may be necessary to augment the instructions provided by the instruction generation system with a translated discussion to address specific issues.

Details of Capturing Instructions for a Single Medication

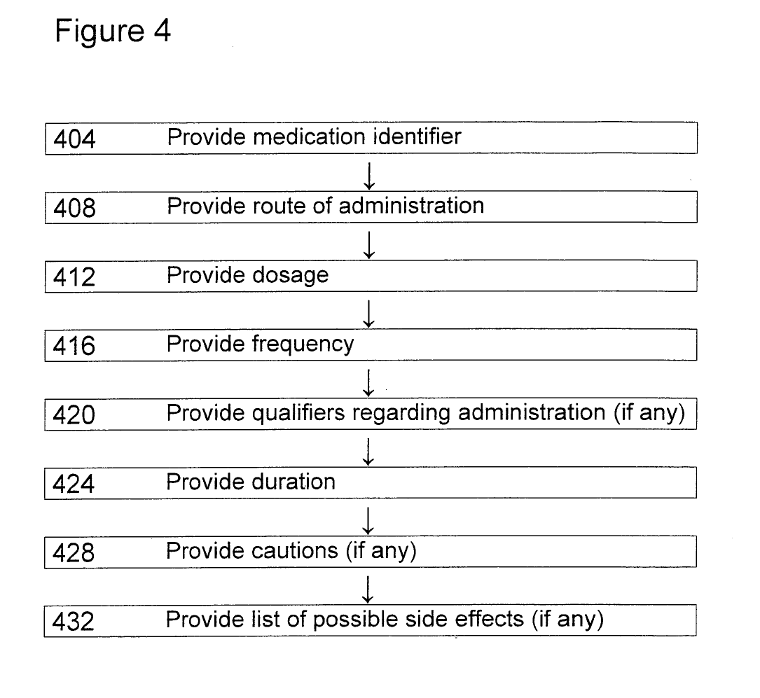

The step 308 in FIG. 3 for obtaining information from the health care provider (user) to be communicated to the instruction recipient about a specific medication can be broken down into a number of sub-steps as shown in FIG. 4.

Step 404 is to provide the medication identifier. Typically, this is a medication name and a strength (example “Ceftin 500 mg”). Some medications come in only one formulation so there is no need to specify the strength. In one embodiment of the present invention, the text provided is merely passed through the system and placed in the written instructions without any further interaction with the software. The audio instructions use the audio phrases (the first medication, next medication, next medication . . . , last medication) rather than any attempts to pronounce the name of the medication in either the language of the user or the language of the instruction recipient. The burden of recording audio for the 65,000 medications would be excessive.

Another embodiment of the present invention could assist the user by providing a list of suggested medications based on the initial letters entered by the user. This would reduce the number of instances of misspelling the medication name and may save the user time inputting letters as the user could accept one of the proffered choices based on the first few letters submitted.

Alternatively, the medication identifier could be a code such as the National Drug Code (NDC) promulgated by the United States Food and Drug Administration. The NDC comprises three numbers separated by hyphens. The first number is an FDA issued institution identifier, the second number is the institution issued product identifier, and the third number is the institution issued package identifier. If a portion of the code is not relevant to this process (such as the package identifier), then the system would not require entry of irrelevant information. Other identification codes could be used such as a formulary ID number for an organization that has a set list of medications that are used. A disadvantage of using a code is that the health care provider or the instruction generation system would need to be able to look up the codes for various medications in order to start this process. One of skill in the art could provide a look-up utility that allowed health care providers to find the relevant code based on the name of the medicine, or the use of the medicine or any other classification that makes sense to the health care provider.

An advantage of using a code for the medication identifier is that the code may convey not only the medication but the strength and the likely route of administration. Thus, if the code indicates a medication in a topical cream rather than in a capsule, then the route of administration is going to be narrowed down to just one or possibly just a few possible routes.

Another possible advantage of using a code so that the system knows the specific medication is that a user specifying a brand name drug could be presented with options to indicate whether a generic can be substituted. However, a user that specifies a medication name that is a generic would not be presented to with irrelevant choices about allowing a generic substitute (for a generic medication).

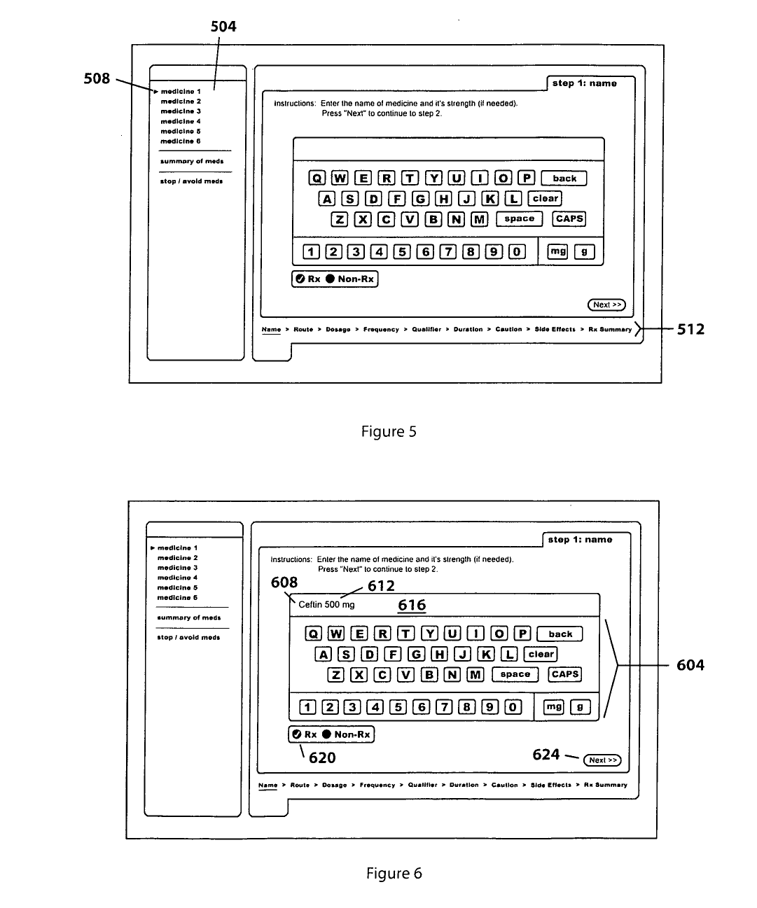

FIG. 5 shows a touch screen presented to a user to collect the information for a medicine. FIG. 5 illustrates one interface for use in an instruction generation system. The left side of the screen shows a navigation panel 504 to A) enable entry for multiple medication instructions (this screen show up to 6 selectable instructions), B) jump to an area to print/speak summary of all medicines instructions, and C) jump to an area to generate a list of medicines to be stopped or avoided. Arrow 508 indicates that the information is being collected for the first medication. The bottom 512 of this screen indicates all the steps in the process, and the current step is highlighted.

FIG. 6 illustrates the one example of the process to provide the medication identifier. Using the keyboard 604 on the touch screen or using a physical keyboard in communication with the instruction generation system, the name and strength of the medicine are entered. (The present invention is not limited to the specific input means used to input information and one of ordinary skill in the art could substitute other common input forms such as voice recognition, handwriting recognition, or other input modes to provide some or all of the input referenced in this application.)

FIG. 6 shows the name 608 which in this case is “Ceftin” and the 612 strength which in this case is “500 mg” in the text box 616. In addition, notice that the Rx field 620 located underneath the on-screen keyboard is checked. Rx and Non-Rx are mutually exclusive items which will instruct the patient if the medicine can be purchased without a prescription. One use of the non-RX designation is that an additional instruction can be added to both the written and audio instruction to convey that this particular medication can be purchased at a drug store without a prescription. Upon completion of the medicine name, the user clicks on the “Next>>” button 624 to move onto the next step.

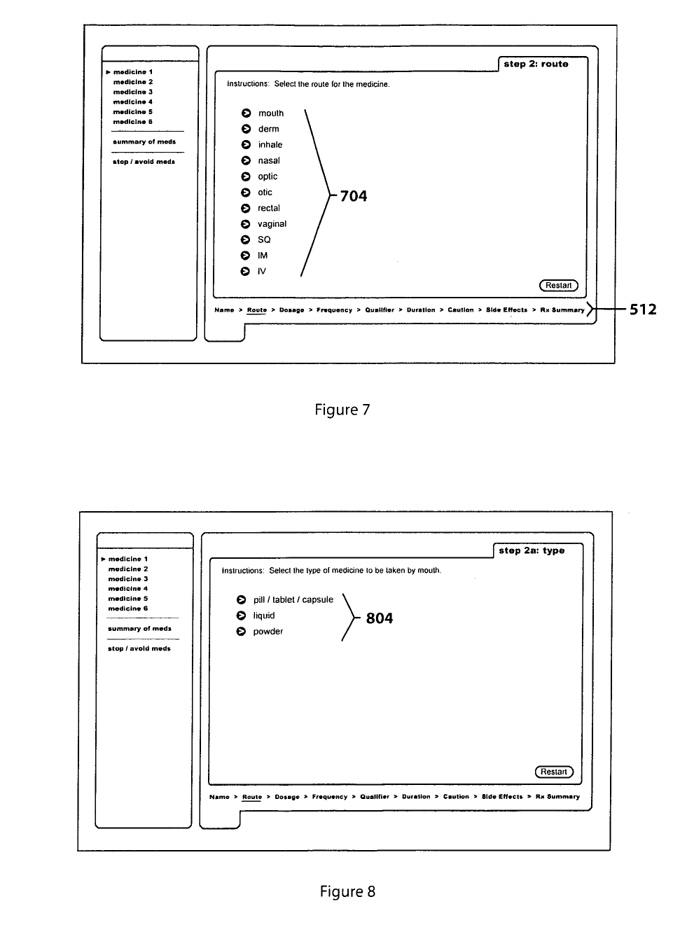

Returning to FIG. 4, step 408 is the provision of the route of administration for the medication. FIG. 7 shows a user interface to obtain this information. The bottom 512 of this screen indicates all the steps in the process, and the current step is highlighted.

The user must now select a route of administration for this particular medicine. FIG. 4 illustrates the options available for route of administration. Selecting one of these routes of administration from the set of displayed routes of administration 704 takes the user to the next step. Note that the routes of administration can be displayed using jargon that makes sense to the user such as SQ for subcutaneous. It is desirable to winnow down the set of possible routes of administration from the overall set of a routes if that can be done based on the medicine identifier (such as when a very specific code is provided). To the extent that a medicine identifier indicates a very specific form of a medication (such as an inhaler for a particular medicine) then the route of administration would be known and this step could be skipped for that medicine. However, it may be preferable to simply provide a list with only one choice so that the user is not confused when the system appears to skip a step. To restart the current medication instruction, the user would press the “Restart” button 708. Those of skill in the art will recognize that another useful tool in a user interface is to allow a back button to allow a user to move to a previous screen to alter or augment the information submitted from that input screen. Nothing in this invention precludes the use of a “back” button.

Sometimes the step of specifying the route of administration is broken down into sub-steps. FIG. 8 shows a second screen that is presented when the user specified “mouth” as the route of administration. FIG. 8 allows the user to specify the type of medicine to be delivered by mouth. The set of relevant types 804 is provided.

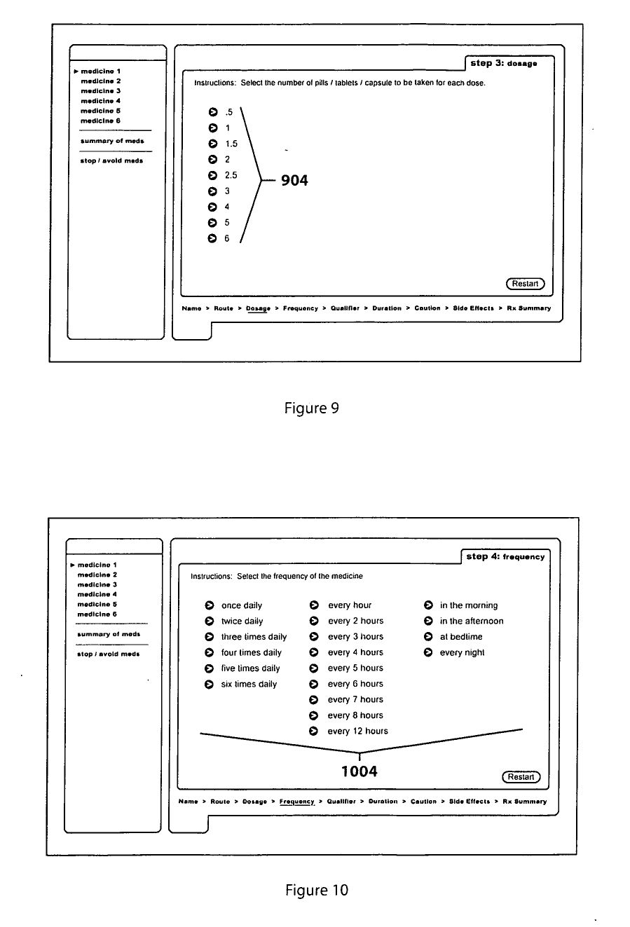

Returning to FIG. 4, the step 412 is the provision of the dosage. FIG. 9 illustrates a set of dosage options 904 that are relevant for the route of administration being mouth and pill/tablet/capsule. Selecting one of these choices moves the process to the next step.

Returning to FIG. 4, the step 416 is to provide the frequency of administration of the medicine dose. FIG. 10 illustrates an input screen with a list of frequency choices 1004.

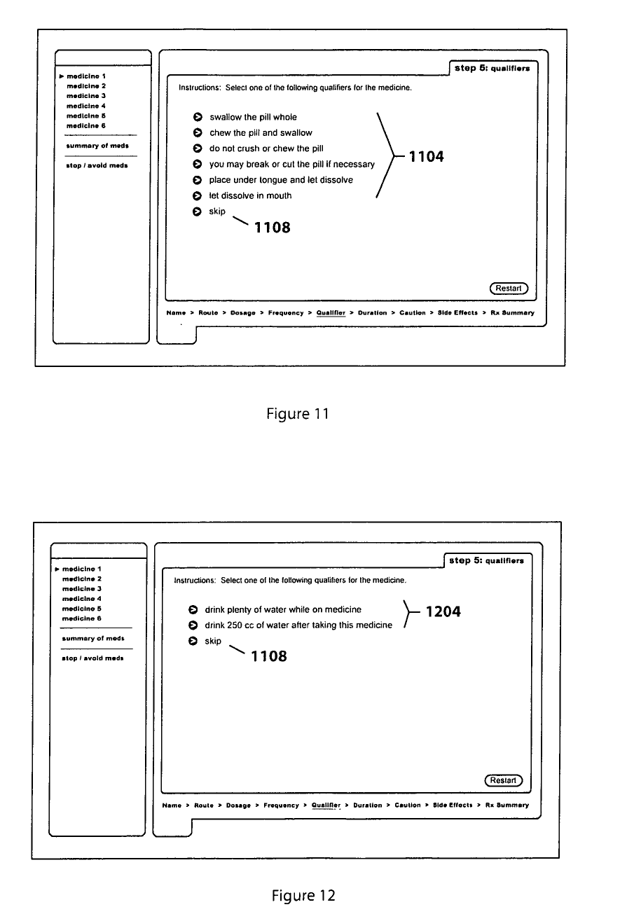

Returning to FIG. 4, the step 420 is to provide any necessary qualifiers regarding the route of administration. FIG. 11 illustrates the provision of a list 1104 of relevant qualifiers for mouth and pill/tablet/capsule. In some instances no additional qualifier is needed and the user can elect to move on without specifying a qualifier using the skip button 1108. Again if there are no possible qualifiers for a previously selected route of administration, the instruction generation system could skip the qualifier step but it may be better to simply provide the screen with the choice of skip and no list of qualifiers. Note that as both the qualifiers and the dosage choices are based on the route of administration, one could do these two steps in either order. This is illustrative of a more generalized point that while the process for collecting input is thought to track the way that health care providers think about the constituent components of generating an instruction regarding a medication, the specific order for collecting information could be rearranged while keeping with the scope of the present invention.

FIG. 12 provides a second screen of qualifiers for the route of administration of mouth and pill/tablet/capsule. FIG. 11 addressed the placement and handling of the medicine. FIG. 12 provides a set of qualification choices 1204 regarding the use of water in connection with this medication. Again FIG. 12 provides a skip button 1108. Selecting skip button 1108 FIG. 11 would advance the process to FIG. 12.

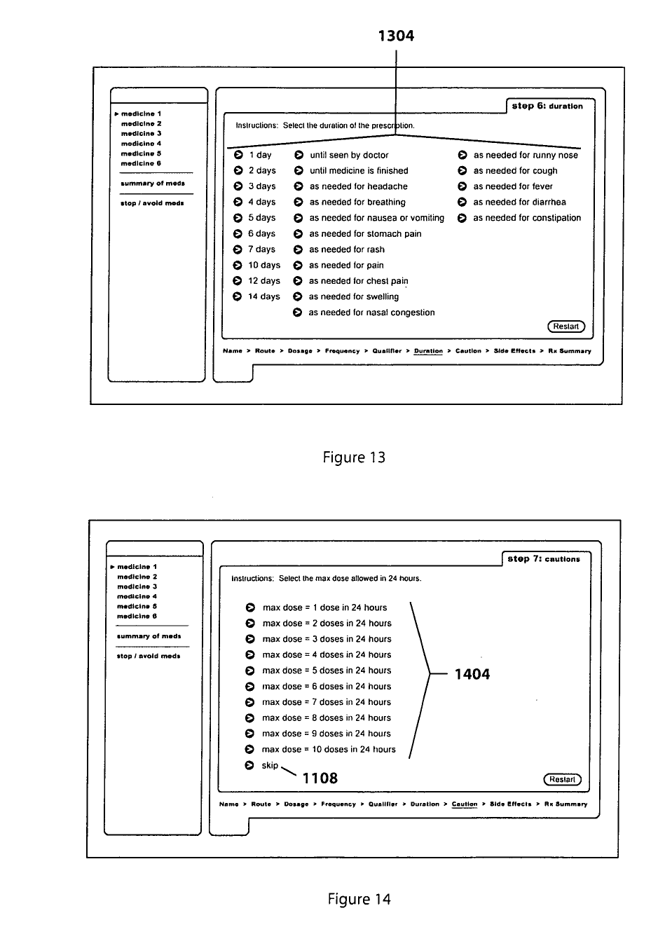

Returning to FIG. 4, step 424 is providing the duration of treatment. FIG. 13 illustrates the presentation of a set of durations 1304. Note that the concept of duration can include the use as needed to control a particular symptom or can include continuing until a specific event such as being seen by a doctor. While the list presented in FIG. 13 is illustrative of a range of duration values, it is not an exhaustive list. If the medication identifier has been a very specific code then the duration choices would tend to have a smaller range of as needed for [symptom] choices as a specific medication would tend to be used to treat a limited set of symptoms.

Returning to FIG. 4, step 428 is providing cautions relevant to this medication. FIG. 14 shows one screen providing a set of choices 1404 for a maximum dosage caution. Again a skip button 1108 is provided if the user does not wish to give any maximum dosage caution. As with qualifiers, after selecting a maximum dosage caution or the skip button, another screen with choices for another caution (and a skip button) could be provided. For example it may be appropriate to caution that the patient should not drive after consuming the medication.

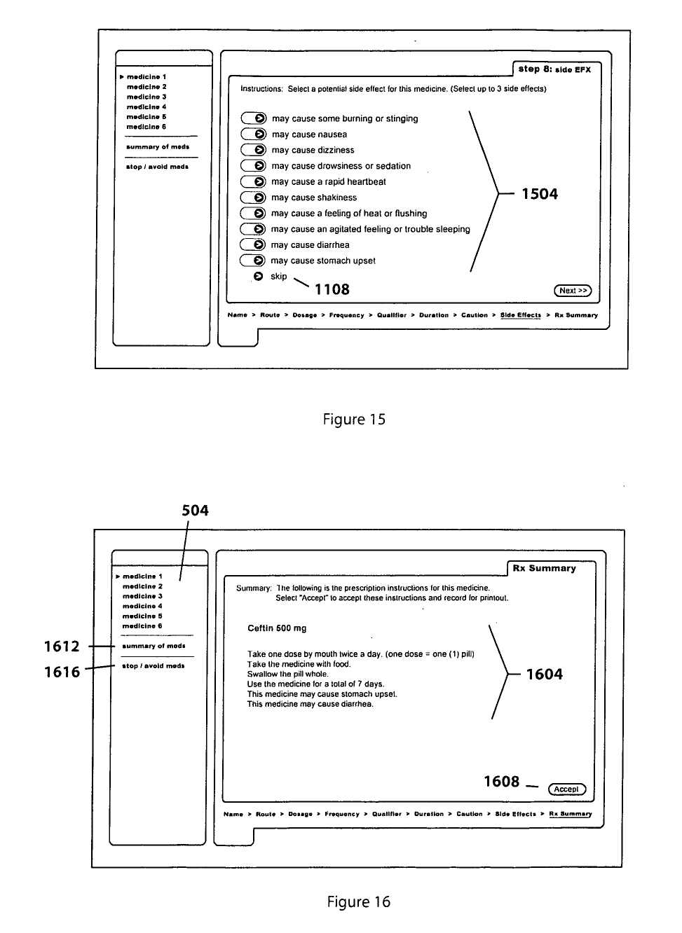

Returning to FIG. 4, step 432 is providing a list of possible side effects. FIG. 15 illustrates a screen presenting a set of side effects 1504 and a skip button 1108. FIG. 15 differs from earlier screens in that the user can select zero, one, two, or three side effects without leaving the screen. Upon selecting a third side effect, the user is advanced to the next step in the process. If the user wishes to provide fewer than three side effects, the user may advance to the next step in the process by actuating the skip button 1108. The invention is not limited to a system that has a cap of three side effects. Three is used in this example as three is thought to be a useful number as there is a belief that providing two or three side effects has more impact than providing a litany of ten side effects.

Returning to FIG. 3, step 308, to receive information from the user to be communicated to the recipient about a medication is now complete for medicine 1. Step 312 is to have the user confirm that the information collected for that mediation is correct. FIG. 16 illustrates a screen that provides the user with a chance to review the inputs 1604 provided in connection with medicine 1. If acceptable, the user is requested to click on the “Accept” button 1608 to indicate that the instruction is correct. Actuating the accept button 1608 submits the information as the first completed medicine instruction. Each completed and accepted medicine instruction will contain a check mark next to the medicine number on the navigation panel on the left side of the screen 504. If the user does not find the instructions acceptable, the system could allow the user to restart the process of providing instruction concepts for this medication through use of the navigation section 504 to re-initiate the process of providing information for medication one (in this instance). Alternatively, the system could provide user interface tools to allow the user to back return to the previously completed input screens to alter the inputs provided. If the user made a mistake on the route of administration is may be efficient to re-initiate the collection of instruction concepts for this medication rather than back up through the screens to the point where route information is collected.

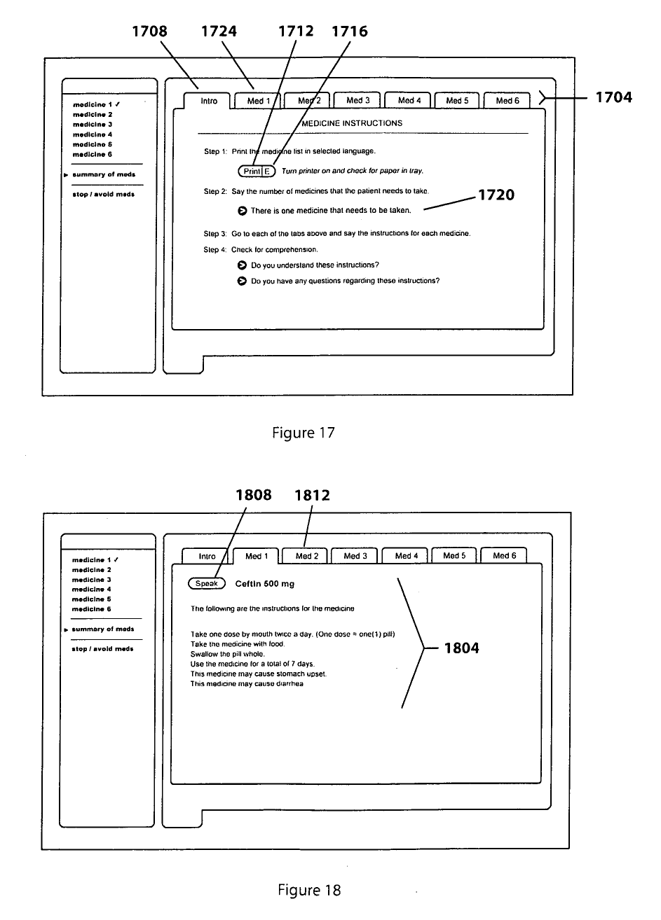

Returning to FIG. 3, after completing step 312 the user must decide if there is another medication to be given to the patient. If the answer is no, and the user does not have a need to convey stop medication or avoid medication instructions (discussed in detail below), the user can navigate by selecting the summary of meds button shown on FIG. 16 to move to a screen as shown in FIG. 17.

FIG. 17 has a set of horizontal navigation tabs 1704. The first tab 1708 provides the options provided on FIG. 17. Note that Step 1 on this screen is to print the medicines and their instructions. Activating the print button 1712 causes the printing of the instructions in the language of the recipient. Activating the user copy button 1716 causes the printing of the instructions in the language of the user (in this case the button is marked E for English). In one embodiment of the invention there is an intermediate step between actuation of buttons 1712 or 1716 and the actual printing. The text to be printed is displayed on a print preview screen and then the user pushes a print button to send the printed material to the printer and return to the user to the screen shown in FIG. 17. While the instructions themselves are in a language other than the primary language of the user, there is still value in this preview step. First, as the medications are printed without translation, the user can view the printout and confirm that there is a block of instructions for each of the medications. Second, it is useful in some programming languages to generate the printed text first before sending the text to the printer when the text contains foreign language fonts. Third, users are simply accustomed to seeing printout before it is routed to a printer. Some users may prefer a system that simply allows the print preview to toggle from the language of the instruction recipient to the language of the user and back again.

Step 2 on FIG. 17 is to let the recipient know how many medications are to be discussed. While the user did not explicitly enter this information into the instruction generation system, the system knows how many medications have instructions accepted by the user. In this case that is just one. An audio file indicating the number of medications to be discussed is played for the recipient by actuating button 1720.

The next step after informing the instruction recipient the number of medications to be discussed is to start the process of conveying the specific information for each medication. The user moves from the screen shown on FIG. 17 to the screen for providing the audio information for the first medication by actuating the Med 1 button 1724. Actuating the Med 1 button 1724 moves the process to the screen shown in FIG. 18.

FIG. 18 provides a set of text 1804 to the user in the user's language of what is about to be conveyed to the instruction recipient. The set of text 1804 is apt to be essentially the text previously accepted by the user, with perhaps an introductory phrase or some other modification for the presentation to the recipient. It may not be a word for word translation of the audio text to be provided to the recipient as some languages differ in the sentence structure and idioms so that a word for word literal translation between the language of the user and the language of the recipient may be less useful than a translation of the concept from one language to the other.

From the screen shown on FIG. 18, the user can actuate a speak button 1808 to request that the instruction generation system play audio instructions for the recipient. Details on the creation of the audio files are discussed below.

If there are additional medications to be discussed, this process can be repeated by moving to a similar screen with instructions for Medication 2 by actuating button 1812. In this example there is only one medication.

Instructions to Stop or Avoid Certain Medication

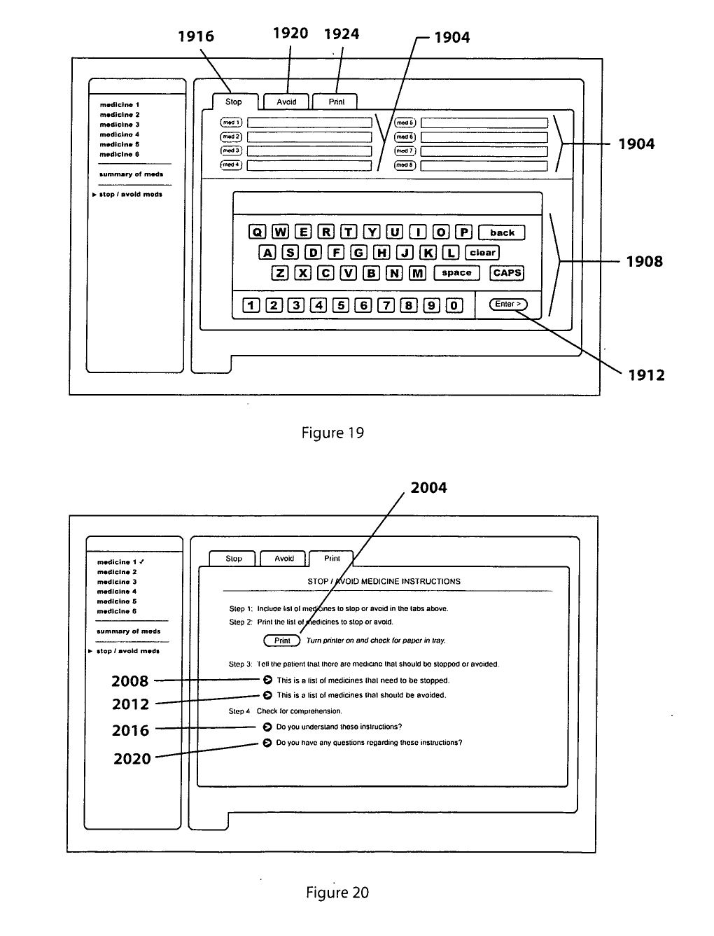

In addition to having a patient take new medicines, a patient may also need to be instructed to stop a current medicine or to avoid other medicines. In some instances, the user may need to provide instructions to stop a current medicine or avoid another medicine even if the user is not suggesting that new medications be started. In such an instance, the instructions to the recipient would contain the stop/avoid instructions but no instructions for new medicine. The collection of instructions for stopping or avoiding medicine can be accomplished through the “stop/avoid meds” section. This portion of the instruction generation system can be accessed through the navigation section 504 on the left side of the screens such as the screen shown in FIG. 16 through activation of a stop/avoid meds button 1616. After actuating button 1616, the user is provided with the input screen presented in FIG. 19.

In this embodiment, the user can enter up to eight medicines to stop into the stop medicine slots 1904. The user enters the name of each medicine through use of the keyboard 1908 presented on the screen or some other input device associated with the instruction generation system. Submitting an enter command through activation of the enter button 1912 places the text identifying the medicine into one of the eight available medicine slots 1904. Adding additional medicine names enters the name in the next available medicine slot. The user may remove a medicine name from a slot by pressing the button to the left of the name in the relevant medicine slot (such as button 1916).

The same set of steps can be used to collect the names of medicines to avoid by actuating the avoid tab 1920. While the concept of stop could be viewed as a particular type of avoid (avoid it even if you have been previously instructed to take it) such that there was only one list of things to avoid rather than a separate list for things to stop, it is conventional for healthcare providers to provide instructions to stop taking a prescribed medication separately from asking the patient to avoid another medication.

After the user has finished entering the medicines to stop and the medicines to avoid, the user would then select the “Print” tab 1924. The user would be presented a screen like the one shown in FIG. 20. When the user actuates the print button 2004 the instruction generation system creates a printout of the medicine names with the title: “List of medicines to stop:” and “List of medicines to avoid:” printed in the selected foreign language. It is useful to place a header on each page in the language of the user that identifies the page as the list of medicines to stop or the list of medicines to avoid. The printout is given to the patient. In one embodiment the list of medicines to stop or avoid is simply reproduced in the same manner as typed by the use without any translation as it is likely that the medications will be labeled in the language of the user rather than the language of the recipient and this list can be provided to other health care providers as needed.

Actuating button 2008 causes the instruction generation system to play audio in the language of the recipient that “This is a list of medicines that need to be stopped.” In connection with the playing of that audio instruction, the user provides the instruction recipient with the printed instruction list that has the list of medicines to be stopped. The medications to be stopped would be written in the language of the user as that is the language that would be found on the labeling of the medications. Fortunately, this use of the printed medication names in the language of the user eliminates the need for translations of tens of thousands of possible medications into each of the languages used by instruction recipients.

Actuating button 2012 causes the instruction generation system to play audio in the language of the recipient that “This is a list of medicines that should be avoided.” In connection with the playing of that audio instruction, the user provides the instruction recipient with the printed instruction list that has the list of medicines to be avoided. The medications to be avoided would be written in the language of the user as that is the language that would be found on the labeling of the medications. Fortunately, this use of the printed medication names in the language of the user eliminates the need for translations of tens of thousands of possible medications into each of the languages used by instruction recipients.

The recipient is then asked in the language understood by the recipient if the recipient understands the directions by actuating button 2016. The recipient is then asked in the language understood by the recipient if the recipient has any questions by actuating button 2020. Instructions provided to the recipient either at the beginning of the exchange of information or at this stage provide instructions on how to convey that the recipient understands or does not understand the instructions (such as speaking “yes” or “no” in the language of the user or nodding the head in a first way to convey yes and a second way to convey no).

Generation of Translated Instructions

The present invention does not use an on-the-fly translation engine to create the written and audio instructions. The present invention collects some text but that text is passed to the written instructions without translation. In one embodiment, the audio instructions referencing medicines does not name the medicines but references them such as first medicine, next medicine, last medicine, or a printed list of medicines. This eliminates the need to prerecord audio for all possible medicines in the language of the user or employ a text to audio conversion program which would be difficult for the idiosyncratic medicine names. The specific instructions associated with a medication are provided to the user as choices. There is not a one to one correspondence between inputs and instructions as some of the inputs regarding route of administration are used to narrow the subsequent choices for other instructions to ones that are relevant to this specific route. Thus, the instructions will not say “the route is by mouth”, the medication is a pill/tablet/capsule, but will rather combine that information with other information such as dose to provide an instruction “Take one dose by mouth twice a day”.

It is advantageous to prune down the choices presented to the user based on the route of administration as many instructions are not relevant to medications administered by certain routes of administration. If the medication identifier is provided using a code understood by the instruction generation system, then there are additional opportunities to limit the set of instructions presented to the user as only a subset of instructions would be relevant to a particular medication.

After a set of instructions are collected from the user for a particular medication (step 308 of FIG. 3) and the user has confirmed the accuracy and completeness of the collected set of instructions in step 312 of FIG. 3, then the instruction generation system has a set of written instruction choices in the language of the user. For each supported recipient language there is a corresponding set of written instructions. Thus an instruction set for a particular medication is a set of instruction couplets (user language/instruction RX2002, user language/instruction RX0002, user language/instruction RX3001, . . . ). If the written instructions are not context dependent as the instructions are in the form of simple commands, “Take one dose by mouth twice a day”, then there can be a one-to-one relationship between the written instructions in the user language and the written instructions in a particular recipient language. Thus, the written instructions are generated by substituting the corresponding instructions from the particular recipient language (language 02/instruction RX2002, language 02/instruction RX0002, language 02/instruction RX3001 . . . ).

It is advantageous, although not required, to provide some instructions using a set of contextual variations when providing audio instructions. While it is felt that this is less necessary for written instructions, written instructions could be created as described below for audio instructions.

Instructions with contextual variation are created by passing both the instruction code and a context. For example the context can be concatenated to the end of the instruction. For example if the instruction is “Take one dose by mouth twice a day” then the a health care provider explaining this to a recipient would say one of three things if they both spoke English: a) You need to take one dose by mouth twice a day; b) She needs to take one dose by mouth twice a day (where the patient is not the instruction recipient and the patient is female); or c) He needs to take one does by mouth twice a day.

In order to get the appropriate pre-recorded audio file selected to be part of the audio instructions for this medication, the instruction choice and context would need to be specified. Thus, the instruction generation system would request audio instruction RX2002a, RX2002b, or RX2002c based on the context from the set of instructions for the language used by the instruction. As illustrated by this example, the written instructions could be context specific if the added work of creating and storing the various context specific variations was deemed justified by the value of having context specific written instructions.

Some instructions do not vary with context. For example the instruction code RX0002 for the concept “one does=one (1) pill” does not vary with context. Thus the instruction/context couplet could be represented as RX0002x where x indicates that there are not context variations for this instruction.

If an instruction varies with context in some languages but not in all languages this could be handled in a number of ways including simply storing with the information for that language the same instruction for each context.

However it would be more efficient to store the information once in a context neutral way if context does not matter and in context specific ways if it does. For example, an instruction provided to a recipient that references the recipient's spouse might be gender neutral in a language that has the word spouse. But the same informational content may require two audio instructions in a language that does not have the gender neutral term of spouse but instead uses wife or husband. So the instruction for language 02 for a given concept may be stored as L02RX0002a (as it works for both male and female as the language has a term spouse) but the same concept may need to be stored in language 04 as L04RX002af (for female as it uses the word husband) or L04RX002am (for male as it uses the word wife). The software can be directed to look first for an instruction ending in “a” but if it cannot find that, then use context to select between the instruction ending “af” and the instruction ending “am”.

Adding support for another recipient language is achieved by providing to the instruction generation system a set of written instructions in the new language for each of the possible written instructions (including contextual variations if used for written instructions) and a set of audio instructions in the new language (including contextual variations if used for audio instructions). One of skill in the art will appreciate that the software used to drive the displays and printers may need to receive language pack extensions to support providing output in additional character sets.

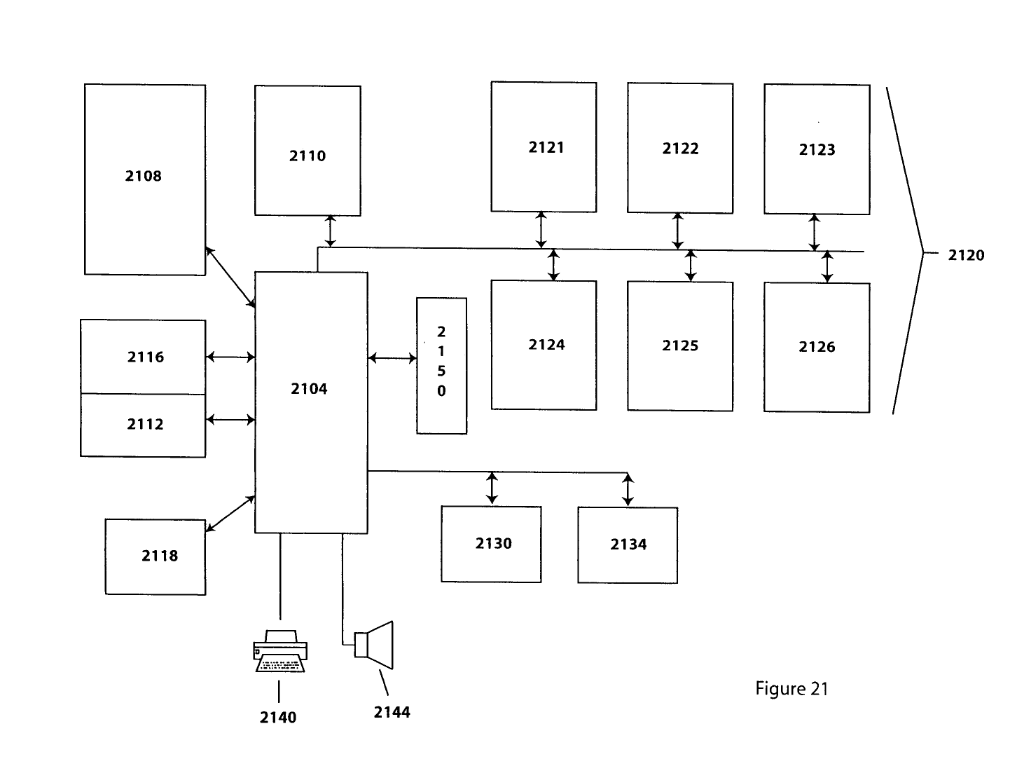

The process of creating instructions in a second language can be represented at a high level as shown in FIG. 21. The instruction generation system program 2104 operating through user interface 2108, collects from the user information including the language that the recipient understands and the context of the conversation 2112 possibly including context information about the recipient or information about the patient to receive the medication. As detailed above, the user interacts with the system to provide responses to a series of input screens to communicate a set of instruction concepts 2116 related to a specific medication. The instructions comprise as set of codes for instruction content and the corresponding versions of those instruction codes in the language of the user (normally in just the written form but it could be both the written and audio form).

Preferably the concepts are displayed to the user by combining the concepts and the corresponding instructions taken from the instruction set 2110 for the user's language (for example English). This set of instructions in the user's language is represented by instruction set 2118. Normally, this is just a written set of instructions which can be displayed to the user during the confirmation step and selected for printing. As it is only written instructions, in one embodiment the mapping of concepts to instructions does not include the use of context but a designer may choose to have context variations in the written or displayed material in the user's language.

The instruction generation system 2104 then creates a set of written instructions 2130 and a set of audio instructions 2134 by accessing a collection of information for a particular language understood by the recipient (for example 2121) out of a set of collections 2120 for a set of different languages (for example: Spanish, Mandarin, Korean, Cantonese, Arabic, Farsi, Russian, Polish, Hmong, et cetera).

Some instructions are selected based on a combination of the instruction concept selected by the user and context information about the conversation such as information about the recipient and the patient. In one embodiment, the written versions of the instructions are selected exclusively on concept and at least some of the audio instructions are selected based on a combination of concept and context. Other embodiments may select at least some of the written instructions based on both concept and context.

The instruction sets in both the user language 2118 and the recipient language 2130 can be routed to a printer 2140. The audio instruction set 2134 can be routed to a speaker 2144.

Note that some of the text that is included in the written or audio files may be binder material that is not explicitly selected by the user but is useful when providing the instructions. For example the instructions provided to the recipient may include a general instruction that gives a contact address and phone number if there are any problems or an instruction to keep the written instructions for reference and bring the copy of the instructions in the user's language if it becomes necessary to return to the emergency room. These standard instructions can be viewed as implicitly selected by the user to provide to the recipient as part of standard procedure.

FIG. 21 illustrates the concepts related to creating the various instruction sets 2118, 2130, and 2134 for a particular medication. This process can include the passing of some free formatted text from the user interface to the instruction sets without translation such as a free formatted text entry for a medication that would be provided to the instruction sets without translation or other modification. For example the word Ceftin could be provided to the instruction texts without translation or modification.

In systems that use a medication identifier that is a code rather than free formatted text, the instruction generation system program 2104 could access a code converter module 2150 to convert the medication identifier to information useful by the instruction generation system program such as the name of the drug and other information conveyed by the code such as strength and the implied route (or possible routes) of administration. Thus an albuterol inhaler that is indicated with specificity by the code would convey medicine name, strength per puff, and route of administration. Knowing the medication with specificity and the route of administration would allow the user interface to limit the presented choices to the user to those that are relevant to this specific medication. For example, the user would not be presented with the instruction concept “take as needed for pain” if this medication is not known to be efficacious to treat pain.

FIG. 21 is useful to provide concepts but should not be taken as a requirement for how information is stored. One of skill in the art could store all of the various instructions for all supported languages in one data base. It may be efficient to separate the text files from the audio files. The instructions for the user language could be stored in the same location as the various collections of instructions for the recipient languages (thus instruction set 2110 in the language of the user could be stored with the set of collections 2120 for different recipient languages).

A system designer could couple the concept and context information before seeking the appropriate instruction from the set of collections 2120 as indicated above, or the context information can be provided once and the set of collections 2120 would respond with the appropriate instructions in the proper language and with appropriate context where context matters.

The instruction generation system could be distributed across a number of resources using a combination of communication links including wired and wireless links. Thus one or more of the collections of information (2121-2126) could be at a location remote from the user and accessed by a communication network.

The examples given about discuss the presentations of instructions using audio files. The scope of the present invention should not be interpreted to exclude presentations to the instruction recipient that are a combination of video and audio or are exclusively video. For example, the recipient could be provided with a set of instructions presented with both text displayed to the screen and audio. The instructions could be supplemented with video clips to illustrate the proper technique for administration of the medication.

The invention set forth above was explained in the context of providing instructions for taking medication. Those of skill in the art recognize that this invention could be extended to other situations where there is a constrained exchange between an expert and a person receiving instructions about the use of some tool or chemical. (A constrained exchange is necessary so that the range of instructions is finite as this system does not use rely on an on-the-fly translation engine.) For example, a rental service that provides equipment might find it useful to provide instructions about the equipment in both audio and written form before the person renting the equipment leaves the rental facility. The use of chemicals such as paint strippers, pesticides, or even fertilizers may require detailed instructions on how to apply the chemical and what chemicals to avoid during and after the application of the selected chemical.

One of skill in the art will recognize that alternative embodiments set forth above are not universally mutually exclusive and that in some cases alternative embodiments can be created that implement two or more of the variations described above. In a like manner, one of skill in the art will recognize that certain aspects of the present invention can be implemented without implementing all of the teachings illustrated in the various disclosed embodiment. Such partial implementations of the teachings of the present invention fall within the claimed subject matter unless the claims are explicit in calling for the presence of additional elements from other teachings.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover the legal equivalents. Those unfamiliar with the legal tests for equivalency should consult a person registered to practice before the patent authority which granted this patent such as the United States Patent and Trademark Office or its counterpart.

What is claimed is:

1. A method of constructing an instruction by a user using a first language for delivery to a recipient in a second language, different from the first language; the method comprising:
providing a medication identifier to an instruction generation system;
providing a medication administration route to the instruction generation system;
providing a medication regime to the instruction generation system;
electing to provide at least one medication qualifier to the instruction generation system or to not provide any medication qualifier;
electing to provide at least one medication caution to the instruction generation system or to not provide any medication caution;
electing to provide at least one possible medication side effect to the instruction generation system or to not provide any possible medication side effect; and
playing a set of audio instructions in the second language which convey information comprising: a set of directions for the administration of the medication, any medication cautions provided by the user, and any possible medication side effects provided by the user.

2. The method claim 1 wherein the medication identifier is the name of the medication.

3. The method of claim 1 wherein the medication identifier is the name of the medication and the strength for medications that come in more than one strength.

4. The method of claim 1 wherein the medication identifier is a code that conveys the medication name and designates one of several particular strengths for that particular medication.

5. The method of claim 1 wherein the medication identifier is a code contained in the National Drug Code published by the United States Food and Drug Administration.

6. The method of claim 1 wherein the step of providing the medication identifier precedes the step of providing the medication administration route is as the step of providing the medication administration route is performed by selecting from a set of medication administration routes that are associated with that particular medication identifier.

7. The method of clam 1 where the step of providing a medication route includes specifying the form of the medicine to be provided by that medication route.

8. The method of claim 7 wherein the user selects from a set of possible dosage choices provided by the instruction generation system where the dosage choices are relevant to the provided medication administration route and form of the medicine.

9. The method of claim 1 wherein the step of providing the medication regime to the instruction generation system includes the sub-steps of:
providing a medication dosage to be used during administration of the medication;
providing a medication application frequency; and
providing a duration for the medication regime.

10. The method of claim 9 wherein the user selects from a set of possible dosage choices presented by the instruction generation system that are relevant to the provided medication administration route.

11. The method of claim 1 wherein playing the audio instruction in the second language conveys a set of directions for the administration of the medication based at least in part on the provided medication regime and any provided medication qualifiers.

12. The method of claim 1 wherein the step of electing to provide at least one medication caution includes selecting from a set of medication cautions associated with the information previously provided by the user to the instruction generation system.

13. The method of claim 12 wherein the information previously provided to the instruction generation system includes the medication identifier.

14. The method of claim 12 wherein the step of electing to provide at least one medication caution includes selecting from the set of medication cautions associated with the information previously provided by the user to the instruction generation system and an option to end the step of electing to provide at least one medication caution without providing a medication caution.

15. The method of claim 1 wherein the step of electing to provide at least one possible medication side effect includes selecting from a set of possible medication side effects selected for presentation to the user based on the information previously provided by the user to the instruction generation system.

16. The method of claim 1 further comprising the step of displaying to the user the series of inputs provided by the user for that particular medication wherein the user can review the captured inputs and accept the set of inputs for that medication.

17. The method of claim 16 wherein after the user that accepts a set of inputs for a particular medication, the user can elect to provide a set of inputs for another medication.

18. The method of claim 17 wherein after the user accepts a set of inputs for a particular medication, the user can elect to enter into a process for conveying information.

19. A method of presenting a set of written instructions for a set of at least one medication, the instructions created in an instruction generation system based on inputs in a first language from a user, the instructions for delivery to a recipient in a second language, different from the first language; the method comprising:
for each medication to be provided to the recipient, receiving a set of inputs from the user comprising information to identify the medication, a set of directions for the administration of the medication, any medication cautions provided by the user, and any possible medication side effects provided by the user;
for each medication to be provided to the recipient, allowing the user to review the set of received inputs and to accept or reject the set of received inputs;
presenting in the second language the number of medicines to be provided to the recipient; and
for each medication to be provided to the recipient presenting in the second language instructions based upon the set of inputs from the user comprising information to identify the medication, a set of directions for the administration of the medication, any medication cautions provided by the user, and any possible medication side effects provided by the user.

20. A method of presenting a set of instructions for a set of at least one medication, the instructions created in an instruction generation system based on inputs in a first language from a user, the instructions for delivery to a recipient in a second language, different from the first language; the method comprising:
for each medication to be provided to the recipient, receiving a set of inputs from the user comprising information to identify the medication, a set of directions for the administration of the medication, any medication cautions provided by the user, and any possible medication side effects provided by the user;
for each medication to be provided to the recipient, allowing the user to review the set of received inputs and to accept or reject the set of received inputs;
presenting in the second language the number of medicines to be provided to the recipient; and
for each medication to be provided to the recipient presenting in the second language written instructions based upon the set of inputs from the user comprising information to identify the medication, a set of directions for the administration of the medication, any medication cautions provided by the user, and any possible medication side effects provided by the user and audio instructions for each of the medications to be provided to the recipient comprising: a set of directions for the administration of the medication, any medication cautions provided by the user, and any possible medication side effects provided by the user.

21. The method of claim 20 further comprising:
after presenting the instructions for the last medication to be provided to the recipient, present to the recipient in the second language an opportunity to confirm that the recipient understands the instructions.

22. The method of claim 20 further comprising:
after presenting the instructions for the last medication to be provided to the recipient, present to the recipient in the second language an opportunity to indicate that the recipient has questions about the instructions.

23. The method of claim 20 wherein the instructions presented to the recipient in the second language are provided by playing a set of at least one audio file.

24. The method of claim 20 wherein the written instructions presented to the recipient in the second language are printed onto a printer associated with the instruction generation system.

25. The method of claim 20 further comprising obtaining an input to the instruction generation system, the input indicative of the second language to be used for presenting information to the recipient.

26. The method of claim 25 wherein the recipient provides the input to the instruction generation system indicative of the second language to be used for presenting information to the recipient.

27. The method of claim 20 wherein the instruction generation system is provided with the gender of the recipient and for at least one second language supported by the instruction generation system, the audio instructions are based upon the gender of the recipient in addition to the set of inputs from the user comprising information to identify the medication, a set of directions for the administration of the medication, any medication cautions provided by the user, and any possible medication side effects provided by the user.

28. The method of claim 20 wherein the instruction generation system is provided with the gender of the recipient and with the gender of the patient to be given the medication and for at least one second language supported by the instruction generation system, the audio instructions are based upon the gender of the recipient and the gender of the patient in addition to the set of inputs from the user comprising information to identify the medication, a set of directions for the administration of the medication, any medication cautions provided by the user, and any possible medication side effects provided by the user.

29. A method of constructing an instruction by a user using a first language for delivery to a recipient in a second language different from the first language, the method comprising:
providing to an instruction generation system using the first language a set of at least one medicine that should not be administered to the patient where the patient may be different from the recipient; and
presenting a written list of the set of at least one medicine that should not be administered to the patient to the recipient in the second language.

30. The method of claim 29 wherein:
the step of providing to the instruction generation system a set of at least one medicine that should not be administered to the patient comprises the option of providing to the instruction generation system a set of at least one previously prescribed medication that should be stopped and includes the option of providing to the instruction generation system a set of at least one medication that should not be given to the patient; and
the step of presenting the written list with the set of at least one medicine that should not be administered to the patient to the recipient in the second language comprises providing the recipient a written list of previously provided medication that should be stopped and an audio instruction in the second language to the recipient that this is the list of previously prescribed medication that should be stopped and providing the recipient with a second written list on a separate piece of paper from the first written list and an audio instruction in the second language to the recipient that this is the list of medications that should not be given to the patient.
